(19) United States
(12) Patent Application Publication
(10) Pub. No.: US 2022/0004398 A1
(43) Pub. Date: Jan. 6, 2022

(54) INTEGRATED CIRCUIT PACKAGE RECONFIGURATION MECHANISM

(71) Applicant: Intel Corporation, Santa Clara, CA (US)

(72) Inventors: Gregory Iovino, Portland, OR (US); Bharat Pillilli, El Dorado Hills, CA (US); Neel Piyush Shah, Billerica, MA (US); Philip Rogers, Hillsboro, OR (US); David Palmer, Beaverton, OR (US)

(73) Assignee: Intel Corporation, Santa Clara, CA (US)

(21) Appl. No.: 17/481,734

(22) Filed: Sep. 22, 2021

(51) Int. Cl. G06F 9/445; G06F 30/34

(52) U.S. Cl. CPC G06F 9/44505; G06F 30/34

(57) ABSTRACT

An apparatus is disclosed. The apparatus comprises an integrated circuit (IC) package including a plurality of ICs; a non-volatile memory to store configuration information comprising settings that define an operation of the plurality ICs and a configuration register to receive configuration bits from the non-volatile memory representing a final configuration for the package

### BACKGROUND OF THE DESCRIPTION

Configuration (or programming) of integrated circuit (IC) packages, such as system on chips (SOCs) entails storing configuration information. However, since the configuration information can only be programmed once, IC packages cannot currently be reprogrammed.

### BRIEF DESCRIPTION OF THE DRAWINGS

So that the manner in which the above recited features of the present embodiment can be understood in detail, a more particular description of the embodiment, briefly summarized above, may be had by reference to embodiments, some of which are illustrated in the appended drawings. It is to be noted, however, that the appended drawings illustrate only typical embodiments of this embodiment and are therefore not to be considered limiting of its scope, for the embodiment may admit to other equally effective embodiments.

FIG. 1 illustrates one embodiment of a computing device.

FIG. 2 illustrates one embodiment of a platform.

FIG. 3 illustrates one embodiment of a system to program an IC package.

FIG. 4A is a flow diagram illustrating one embodiment of a process for programming an IC package.

FIG. 4B illustrates one embodiment of a configuration flow for an IC package.

FIG. 5 is a flow diagram illustrating one embodiment of a manufacturing reconfiguration process for programming an IC package.

FIG. 6 illustrates one embodiment of a schematic diagram of an illustrative electronic computing device.

### DETAILED DESCRIPTION

In the following description, numerous specific details are set forth to provide a more thorough understanding of the present embodiment. However, it will be apparent to one of skill in the art that the present embodiment may be practiced without one or more of these specific details. In other instances, well-known features have not been described in order to avoid obscuring the present embodiment.

In embodiments, a mechanism is provided to reconfigure an IC package to modify package attributes (e.g., stock keeping unit (SKU) attributes). Package configuration is included in a non-volatile storage, which may be configured and reconfigured to modify the package attributes.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to and are not intended to imply that the elements so described must be in a given sequence, either temporally, spatially, in ranking, or in any other manner.

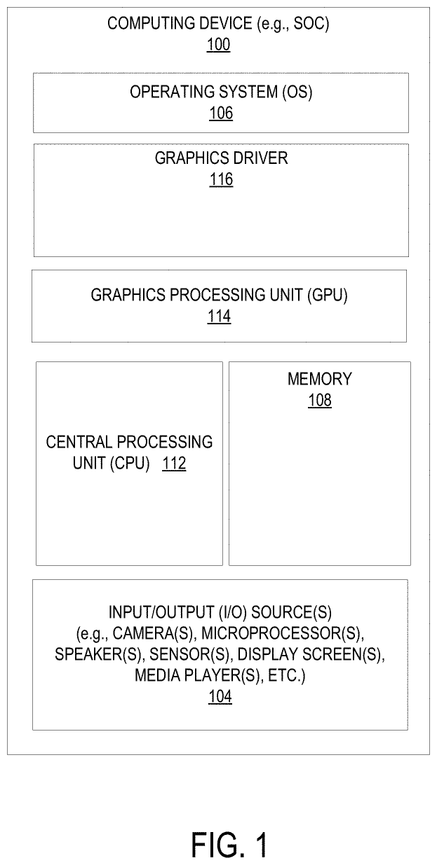

FIG. 1 illustrates one embodiment of a computing device 100. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

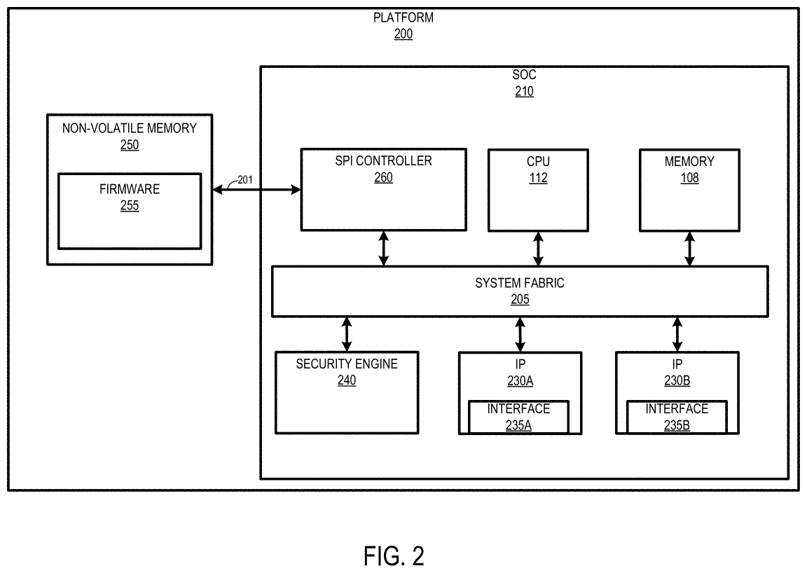

FIG. 2 illustrates one embodiment of a platform 200 including a SOC 210 similar to computing device 100 discussed above. As shown in FIG. 2, SOC 210 includes other computing device components (e.g., memory 108 and CPU 112) coupled via a system fabric 205. In one embodiment, system fabric 205 comprises an integrated on-chip system fabric (IOSF) to provide a standardized on-die interconnect protocol for coupling interconnect protocol (IP) agents 230 (e.g., IP agents 230A and 230B) within SOC 210. In such an embodiment, the interconnect protocol provides a standardized interface to enable third parties to design logic such as IP agents to be incorporated in SOC 210.

According to embodiment, IP agents 230 may include general purpose processors (e.g., in-order or out-of-order cores), fixed function units, graphics processors, I/O controllers, display controllers, etc. In such an embodiment, each IP agent 230 includes a hardware interface 235 (e.g., 235A and 235B) to provide standardization to enable the IP agent 230 to communicate with SOC 210 components. For example, in an embodiment in which IP agent 230 is a third-party visual processing unit (VPU), interface 235 provides a standardization to enable the VPU to access memory 108 via fabric 205.

Further, SOC 210 is coupled to a non-volatile memory 250. Non-volatile memory 250 may be implemented as a Peripheral Component Interconnect Express (PCIe) storage drive, such as a solid-state drive (SSD) or Non-Volatile Memory Express (NVMe) drives. In one embodiment, non-volatile memory 250 is implemented to store the platform 200 firmware 255. In one embodiment, SOC 210 is coupled to non-volatile memory 250 via a serial peripheral interface (SPI) 201. In such an embodiment, SOC 210 includes SPI controller 260 coupled between SPI 201 and system fabric 205. In a further embodiment, SPI controller 260 is a flash controller implemented to control access to non-volatile memory 250 via SPI 201.

SOC 210 also includes a security engine 240 that performs various security operations (e.g., security processing, cryptographic functions, etc.) for SOC 210. In one embodiment, security engine 240 comprises an IP agent 230 that is implemented to perform the security operations. In one embodiment, security engine 240 is a cryptographic processor that operates as a root of trust (or platform ROT) to assure the integrity of hardware and software operating on platform 200. As used herein, a ROT is defined as a set of functions in a trusted computing module within a host that is always trusted by the host's operating system (OS). The ROT serves as separate compute engine controlling the trusted computing platform cryptographic processor, such as security engine 240, on platform 200. Although described above with reference to a single SOC 210, other embodiments may implement any number of SOCs 210.

Components within SOC 210 (e.g., CPU 112 or one or more of IP agents 230) comprise an IC package that must be configured prior to being used. As mentioned above, post package configuration currently involves programming fuse bits during manufacturing, which defines operation of the package when used. However, this package configuration cannot currently be modified. As package complexity increases (e.g., with increasingly more dies being integrated in a package), the cost of scrapping a package also increases since failure of one die in a package translates into discarding the package with multiple die). Thus, scrapping an IC package having working components results in significant cost increases.

According to one embodiment, a mechanism is provided to facilitate reconfiguration of an IC package. In such an embodiment, a non-volatile memory is included within the package to store configuration information that includes settings that are implemented to define the operation of integrated circuits within the IC package (e.g., during the package manufacturing process). In a further embodiment, the configuration information comprises a configuration image that is encrypted with an encryption key that is unique to the IC package. In this embodiment, the encryption key may be decrypted only after reading from the non-volatile memory. In yet a further embodiment, the configuration image is signed with a private key associated with the IC package that is verified using a public key associated with the IC package after being read from the non-volatile memory. In still further embodiments, different cryptographic algorithms (or protocols) may be implemented to provide confidentiality, integrity and replay protection of the non-volatile memory.

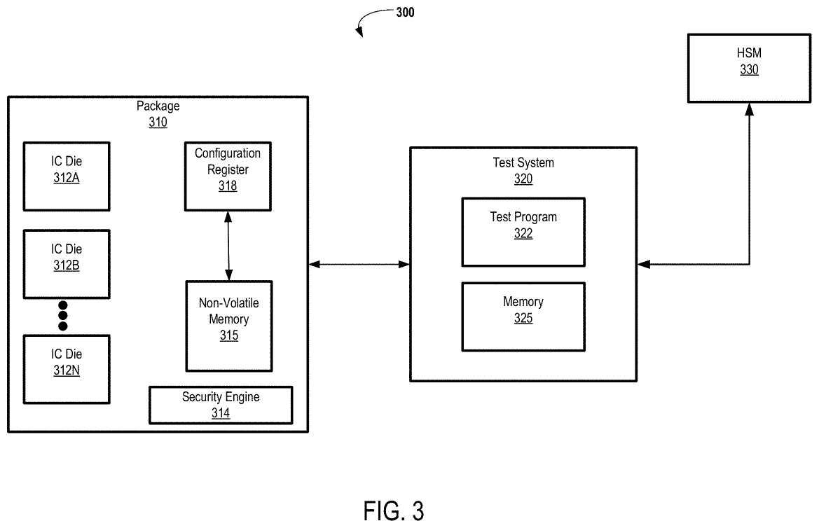

FIG. 3 illustrates one embodiment of a system 300 including a package 310 and a test system 320. As shown in FIG. 3, package 310 includes a plurality of IC die (or ICs) 312 (e.g., 312A-312N), non-volatile memory 315, security engine 314 and configuration register 318. IC die 312 may represent components (e.g., CPU, IPs, security engine, etc.) included in SOC 210 discussed above with regards to FIG. 2.

Non-volatile memory 315 is implemented to store package configuration information that includes settings that define the operation of package 310 (e.g., the operation of ICs 312 within package 310. In one embodiment, non-volatile memory 315 comprises a non-volatile random access memory (NVRAM), or other types of persistent storage elements. In a further embodiment, non-volatile memory 315 comprises a complex programmable logic device (CPLD) NVRAM. Configuration register 318 is implemented to store configuration bits received from non-volatile memory 315. The configuration bits represent the final configuration for package 310.

Security engine 314 is a cryptographic processor implemented to provide security for package 310. In one embodiment, security engine 314 facilitates the entry of package 310 into a secure mode to ensure that only authorized users have access to program and update (e.g., reconfigure) the configuration information to non-volatile memory 315. In such an embodiment, the secure mode is entered into using a private key unique to package 310 to unlock the package 310. In one embodiment, the private key is derived using a secret unlock key. Additionally, a hash of the public key is stored package 310. Thus, the private key is to be reconstructed in order to update the product configuration in non-volatile memory 315 from test system 320. In a further embodiment, an Advanced Encryption Standard (AES) symmetric key for encrypting and decrypting the product configuration is also stored in package 310. Although shown in FIG. 3 as being a stand-alone component, other embodiments may feature a separate security engine 314 within each IC die 312.

During system boot, package 310 comes out of reset and derives its keys. Subsequently, security engine 314 reads the data from the non-volatile memory 315, authenticates the data, performs security checks, and decrypts it using the stored encryption key. The configuration information may then be populated in configuration register 318 as configuration bits. The reset is then completed to allow the configuration to propagate to the rest of the die.

Test system 320 includes a test program 322 that loads package configuration information non-volatile memory 315 and a memory 325 to store received encryption keys received from a high security module (HSM) 330. In one embodiment, the non-volatile memory 315 programming process is similar to the reprogramming process. As a result, a single test program 322 may be implemented to manage the installation of original package 310 programming as well as programming to perform re-configuration.

HSM 330 comprises a computing device including one or more cryptographic processors that generates and stores cryptographic keys that are to be used in system 300. In one embodiment, HSM 330 stores an unlock key that is used to program non-volatile memory 315. In such an embodiment, test system 320 acquires the unlock key from HSM 330 to facilitate programming non-volatile memory 315. Thus, non-volatile memory 315 cannot be programmed/reprogrammed without authentication of test system 320 (or any other entity) via the unlock key, which prevents an unauthorized configuration of non-volatile memory 315.

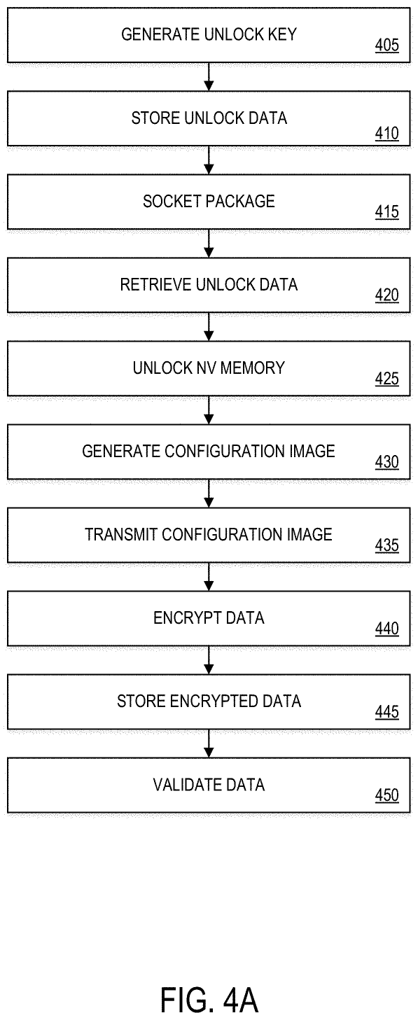

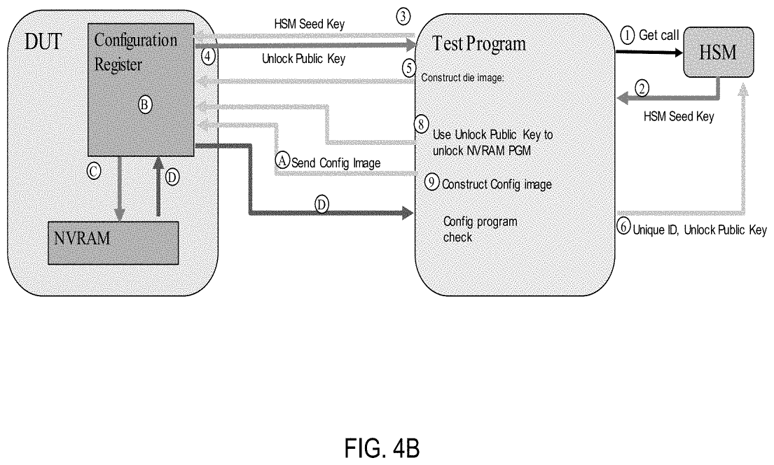

FIG. 4A is a flow diagram illustrating one embodiment of a process for programming an IC package. At processing block 405, an unlock key is generated for the package. In one embodiment, the unlock key is generated using seed bits received from the HSM to generate a unique key associated with the IC package. However, other embodiments may implement different mechanisms to generate the unlock key. At processing block 410, the unlock key and a unique identifier associated with the IC package are stored into the HSM as unlock data for later use. In one embodiment, processing blocks 405 and 410 are performed only during original programming of the IC package.

At processing block 415, the IC package is inserted into a socket for configuration (or reconfiguration). At processing block 420, the test system retrieves the unlock data from the HSM. At processing block 425, the test system uses the unlock data to unlock the IC package. As discussed above, the test system is precluded from accessing the IC package without the unlock data associated with the IC package.

At processing block 430, the test program generates a configuration image that is used to program the IC package. In one embodiment, generating the configuration image comprises generating a package fuse image that is fused into the IC package. During the reprogramming process, the IC package verifies the value of the generated image to determine whether the value is equal to a value associated with a previously stored image. In a further embodiment, the test program generates a string image for configuration programming of the non-volatile memory. In such an embodiment, the test program may compress the string image prior to transmission to the IC package.

At processing block 435, the configuration image is transmitted to the IC package for the programming of the non-volatile memory. At processing block 440, the IC package manages encryption of the compressed data (e.g., via using AES). At processing block 445, the encrypted compressed data is stored in the non-volatile memory. At processing block 450, the non-volatile memory program is validated to confirm that it has been programmed correctly (e.g., determine whether the configuration information received from the non-volatile memory matches the configuration image generated by the test system).

In one embodiment, data is transmitted from the non-volatile memory to the security engine. Subsequently, the security engine decrypts and decompresses the data and then transmits the decrypted/uncompressed data to the test program, where the program is validated to check the programmed image. Decryption and decompression enables an end to end check of the non-volatile memory data for a final configuration into the IC package's configuration register. The test program may reprogram the non-volatile memory upon a determination that the data within the non-volatile memory is incorrect.

FIG. 4B illustrates another embodiment of a configuration flow for an IC package. As shown in FIG. 4B, an unlock key is generated for the package using seed bits received from an HSM to generate a unique key associated with the IC package and the unlock key and a unique identifier associated with the IC package are stored into the HSM as unlock data for later use. Subsequently, the test system retrieves the unlock data from the HSM and uses the unlock data to unlock the IC package. The test program then generates a configuration image and transmits the configuration image to the IC package for the programming of the non-volatile memory. The IC package manages encryption of the compressed data and stores the encrypted compressed data in the non-volatile memory. Finally, the non-volatile memory program is validated to confirm that it has been programmed correctly.

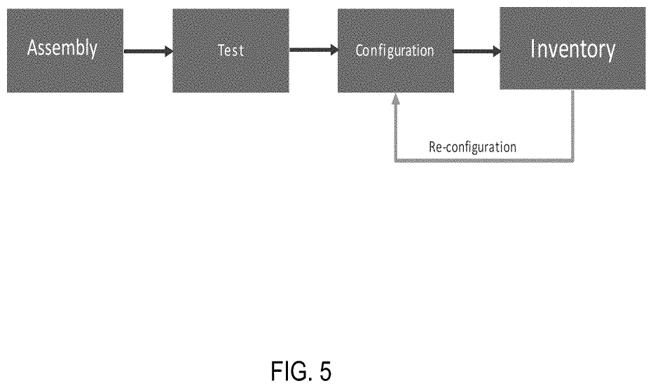

FIG. 5 is a flow diagram illustrating one embodiment of a manufacturing reconfiguration process for programming an IC package. As shown in

FIG. 5, the package is assembled, tested configured, and placed into inventory. Subsequently, the package may be reconfigured after being placed into inventory.

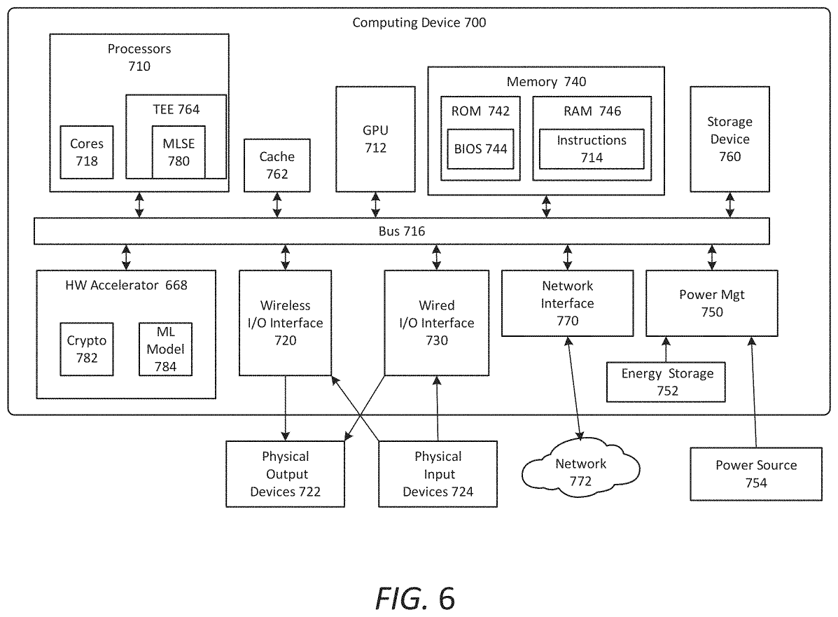

FIG. 6 is a schematic diagram of an illustrative electronic computing device to enable enhanced protection against adversarial attacks according to some embodiments. In some embodiments, the computing device 700 includes one or more processors 710 including one or more processors cores 718 and a TEE 764, the TEE including a machine learning service enclave (MLSE) 780. In some embodiments, the computing device 700 includes a hardware accelerator 768, the hardware accelerator including a cryptographic engine 782 and a machine learning model 784. In some embodiments, the computing device is to provide enhanced protections against ML adversarial attacks, as provided in FIGS. 1-5.

The computing device 700 may additionally include one or more of the following: cache 762, a graphical processing unit (GPU) 712 (which may be the hardware accelerator in some implementations), a wireless input/output (I/O) interface 720, a wired I/O interface 730, memory circuitry 740, power management circuitry 750, non-transitory storage device 760, and a network interface 770 for connection to a network 772. The following discussion provides a brief, general description of the components forming the illustrative computing device 700. Example, non-limiting computing devices 700 may include a desktop computing device, blade server device, workstation, or similar device or system.

In embodiments, the processor cores 718 are capable of executing machine-readable instruction sets 714, reading data and/or instruction sets 714 from one or more storage devices 760 and writing data to the one or more storage devices 760. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 718 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 700 includes a bus or similar communications link 716 that communicably couples and facilitates the exchange of information and/or data between various system components including the processor cores 718, the cache 762, the graphics processor circuitry 712, one or more wireless I/O interfaces 720, one or more wired I/O interfaces 730, one or more storage devices 760, and/or one or more network interfaces 770. The computing device 700 may be referred to in the singular herein, but this is not intended to limit the embodiments to a single computing device 700, since in certain embodiments, there may be more than one computing device 700 that incorporates, includes, or contains any number of communicably coupled, collocated, or remote networked circuits or devices.

The processor cores 718 may include any number, type, or combination of currently available or future developed devices capable of executing machine-readable instruction sets.

The processor cores 718 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The system memory 740 may include read-only memory (“ROM”) 742 and random-access memory (“RAM”) 746. A portion of the ROM 742 may be used to store or otherwise retain a basic input/output system (“BIOS”) 744. The BIOS 744 provides basic functionality to the computing device 700, for example by causing the processor cores 718 to load and/or execute one or more machine-readable instruction sets 714. In embodiments, at least some of the one or more machine-readable instruction sets 714 cause at least a portion of the processor cores 718 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The at least one wireless I/O interface 720 may be communicably coupled to one or more physical output devices 722 (tactile devices, video displays, audio output devices, hardcopy output devices, etc.). The at least one wireless I/O interface 720 may communicably couple to one or more physical input devices 724 (pointing devices, touchscreens, keyboards, tactile devices, etc.). The at least one wireless I/O interface 720 may include any currently available or future developed wireless I/O interface. Example wireless I/O interfaces include, but are not limited to: BLUETOOTH®, near field communication (NFC), and similar.

The computing device 700 may include one or more wired input/output (I/O) interfaces 730. The at least one wired I/O interface 730 may be communicably coupled to one or more physical output devices 722 (tactile devices, video displays, audio output devices, hardcopy output devices, etc.). The at least one wired I/O interface 730 may be communicably coupled to one or more physical input devices 724 (pointing devices, touchscreens, keyboards, tactile devices, etc.). The wired I/O interface 730 may include any currently available or future developed I/O interface. Example wired I/O interfaces include but are not limited to: universal serial bus (USB), IEEE 1394 (“FireWire”), and similar.

The computing device 700 may include one or more communicably coupled, non-transitory, data storage devices 760. The data storage devices 760 may include one or more hard disk drives (HDDs) and/or one or more solid-state storage devices (SSDs). The one or more data storage devices 760 may include any current or future developed storage appliances, network storage devices, and/or systems. Non-limiting examples of such data storage devices 760 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 760 may include one or more removable storage devices, such as one or more flash drives, flash memories, flash storage units, or similar appliances or devices capable of communicable coupling to and decoupling from the computing device 700.

The one or more data storage devices 760 may include interfaces or controllers (not shown) communicatively coupling the respective storage device or system to the bus 716. The one or more data storage devices 760 may store, retain, or otherwise contain machine-readable instruction sets, data structures, program modules, data stores, databases, logical structures, and/or other data useful to the processor cores 718 and/or graphics processor circuitry 712 and/or one or more applications executed on or by the processor cores 718 and/or graphics processor circuitry 712. In some instances, one or more data storage devices 760 may be communicably coupled to the processor cores 718, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or Wi-Fi®, etc.).

Processor-readable instruction sets 714 and other programs, applications, logic sets, and/or modules may be stored in whole or in part in the system memory 740. Such instruction sets 714 may be transferred, in whole or in part, from the one or more data storage devices 760. The instruction sets 714 may be loaded, stored, or otherwise retained in system memory 740, in whole or in part, during execution by the processor cores 718 and/or graphics processor circuitry 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the processor cores 718, the graphics processor circuitry 712, the wireless I/O interface 720, the wired I/O interface 730, the storage device 760, and the network interface 770 are illustrated as communicatively coupled to each other via the bus 716, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor cores 718 and/or the graphics processor circuitry 712. In some embodiments, all or a portion of the bus 716 may be omitted and the components are coupled directly to each other using suitable wired or wireless connections.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising an integrated circuit (IC) package including a plurality of ICs, a non-volatile memory to store configuration information comprising settings that define an operation of the plurality ICs and a configuration register to receive configuration bits from the non-volatile memory representing a final configuration for the package.

Example 2 includes the subject matter of Example 1, wherein the package receives the configuration image from a test system.

Example 3 includes the subject matter of Examples 1 and 2, wherein the IC package further comprises a cryptographic processor to encrypt the configuration information received from the test system and store the encrypted configuration information in the non-volatile memory.

Example 4 includes the subject matter of Examples 1-3, wherein the cryptographic processor authenticates the test system to secure access to the non-volatile memory.

Example 5 includes the subject matter of Examples 1-4, wherein the cryptographic processor receives unlock data from the test system and unlocks the non-volatile memory in response to receiving the unlock data.

Example 6 includes the subject matter of Examples 1-5, wherein the unlock data comprises an unlock key and unique information associated with the IC package.

Example 7 includes the subject matter of Examples 1-6, wherein the cryptographic processor receives the encrypted configuration information to facilitate validation of the configuration information.

Example 8 includes the subject matter of Examples 1-7, wherein the cryptographic processor decrypts the encrypted configuration information and transmits the configuration information to the test system for validation.

Some embodiments pertain to Example 9 that includes a method comprising receiving configuration information at an integrated circuit (IC) package from a test system, wherein the configuration information comprises settings that define operation of the package and programming the configuration information to a non-volatile memory.

Example 10 includes the subject matter of Example 9, further comprising storing configuration bits from the non-volatile memory representing a final configuration for the package to a configuration register.

Example 11 includes the subject matter of Examples 9 and 10, further comprising encrypting the configuration information and storing the encrypted configuration information in the non-volatile memory.

Example 12 includes the subject matter of Examples 9-11, further comprises authenticating the test system.

Example 13 includes the subject matter of Examples 9-12, wherein authenticating the test system comprises receiving unlock data from the test system and unlocking a public key in response to receiving the unlock data.

Example 14 includes the subject matter of Examples 9-13, wherein the unlock data comprises an unlock key and unique information associated with the IC package.

Example 15 includes the subject matter of Examples 9-14, further comprising receiving the encrypted configuration information, decrypting the encrypted configuration information and transmitting the configuration information to the test system for validation.

Some embodiments pertain to Example 16 that includes at least one computer readable medium having instructions stored thereon, which when executed by one or more processors, cause the processors to receive unlock data from a security processor, unlock a non-volatile memory at an integrated circuit package (IC) using the unlock data generate a configuration image and program the non-volatile memory with the configuration image as configuration information, wherein the configuration information comprises settings that define operation of the IC package.

Example 17 includes the subject matter of Example 16, which when executed by one or more processors, further cause the processors to validate the programming of the non-volatile memory.

Example 18 includes the subject matter of Examples 16 and 17, wherein validating the programming of the non-volatile memory comprises determining whether the configuration information received from the non-volatile memory matches the configuration image.

Example 19 includes the subject matter of Examples 16-18, which when executed by one or more processors, further cause the processors to reprogram the non-volatile memory with the configuration image upon a determination that the configuration information received from the non-volatile memory does not match the configuration image.

Example 20 includes the subject matter of Examples 16-19, which when executed by one or more processors, further cause the processors to store the unlock data.

The embodiment has been described above with reference to specific embodiments. Persons skilled in the art, however, will understand that various modifications and changes may be made thereto without departing from the broader spirit and scope of the embodiment as set forth in the appended claims. The foregoing description and drawings are, accordingly, to be regarded in an illustrative rather than a restrictive sense.

What is claimed is:

1. An apparatus comprising:
an integrated circuit (IC) package including:
a plurality of ICs;
a non-volatile memory to store configuration information comprising settings that define an operation of the plurality ICs; and
a configuration register to receive configuration bits from the non-volatile memory representing a final configuration for the package.

2. The apparatus of claim 1, wherein the package receives the configuration image from a test system.

3. The apparatus of claim 2, wherein the IC package further comprises a cryptographic processor to encrypt the configuration information received from the test system and store the encrypted configuration information in the non-volatile memory.

4. The apparatus of claim 3, wherein the cryptographic processor authenticates the test system to secure access to the non-volatile memory.

5. The apparatus of claim 4, wherein the cryptographic processor receives unlock data from the test system and unlocks the non-volatile memory in response to receiving the unlock data.

6. The apparatus of claim 5, wherein the unlock data comprises an unlock key and unique information associated with the IC package.

7. The apparatus of claim 3, wherein the cryptographic processor receives the encrypted configuration information to facilitate validation of the configuration information.

8. The apparatus of claim 7, wherein the cryptographic processor decrypts the encrypted configuration information and transmits the configuration information to the test system for the validation.

9. A method comprising:
receiving configuration information at an integrated circuit (IC) package from a test system, wherein the configuration information comprises settings that define operation of the package; and
programming the configuration information to a non-volatile memory.

10. The method of claim 9, further comprising storing configuration bits from the non-volatile memory representing a final configuration for the package to a configuration register.

11. The method of claim 10, further comprising:
encrypting the configuration information; and
storing the encrypted configuration information in the non-volatile memory.

12. The method of claim 9, further comprises authenticating the test system.

13. The method of claim 12, wherein authenticating the test system comprises:
receiving unlock data from the test system; and
unlocking a public key in response to receiving the unlock data.

14. The method of claim 13, wherein the unlock data comprises an unlock key and unique information associated with the IC package.

15. The method of claim 11, further comprising:
receiving the encrypted configuration information;
decrypting the encrypted configuration information; and
transmitting the configuration information to the test system for validation.

16. At least one computer readable medium having instructions stored thereon, which when executed by one or more processors, cause the processors to:
receive unlock data from a security processor;
unlock a non-volatile memory at an integrated circuit package (IC) using the unlock data;
generate a configuration image; and
program the non-volatile memory with the configuration image as configuration information, wherein the configuration information comprises settings that define operation of the IC package.

17. The computer readable medium of claim 16, which when executed by the one or more processors, further cause the processors to validate the programming of the non-volatile memory.

18. The computer readable medium of claim 17, wherein validating the programming of the non-volatile memory comprises determining whether the configuration information received from the non-volatile memory matches the configuration image.

19. The computer readable medium of claim 18, which when executed by the one or more processors, further cause the processors to reprogram the non-volatile memory with the configuration image upon a determination that the configuration information received from the non-volatile memory does not match the configuration image.

20. The computer readable medium of claim 16, which when executed by the one or more processors, further cause the processors to store the unlock data.
